(19) United States
(12) Patent Application Publication
(10) Pub. No.: US 2009/0058992 A1
(43) Pub. Date: Mar. 5, 2009

(54) THREE DIMENSIONAL PHOTOGRAPHIC LENS SYSTEM

(76) Inventors: Jin Ho Jung, Icheon (KR); Wan Kyo Han, Seoul (KR)

Correspondence Address: IPLA P.A., 3580 WILSHIRE BLVD., 17TH FLOOR, LOS ANGELES, CA, 90010, US

(21) Appl. No.: 12/281,916

(22) PCT Filed: Feb. 2, 2007
(86) PCT No.: PCT/KR07/00579

§ 371 Date: Sep. 5, 2008

(30) Foreign Application Priority Data
Mar. 6, 2006 (KR) 10-2006-0020806
Apr. 11, 2006 (KR) 10-2006-0032659

(51) Int. Cl. H04N 13/02

(52) U.S. Cl. 348/46; 348/E13.074

(57) ABSTRACT

Provided is a three-dimensional image capturing lens system having a structure in which left and right image sensing lenses are provided, and light is synthesized to form an image on a single CCD (charge-coupled device) in order to prevent loss of light intensity.

### TECHNICAL FIELD

The present invention relates to a three-dimensional image capturing lens system for capturing three-dimensional images, and more particularly, to a three-dimensional image capturing lens system having a structure in which left and right image sensing lenses are provided, and light is synthesized to form an image on a single CCD (charge-coupled device) in order to prevent loss of light intensity.

### BACKGROUND ART

Today, with the recognition of the importance of a three-dimensional image, various researches have been conducted not only domestically but also worldwide.

Despite the progress of various researches, however, the researches focus mainly on a display. Thus, there is little progress in the researches on a three-dimensional image capturing apparatus.

Ironically, this is because, regardless of the recognition of the importance of the three-dimensional image, there is a general understanding that image capturing is carried out by using two lens systems at the same time.

However, in practice, the use of the two lens systems causes more problems than when one lens system is used.

First, as shown in FIG. 1, when two lens systems 100 are each constructed with a lens 120 and a main body 110, it is difficult to maintain the same distance as a human eyespot distance.

Second, the two lens systems 100 are not easily synchronized by using electrical circuits.

Third, in terms of expense, the use of two lens systems 100 results in cost increase. Further, it is difficult to uniformly operate a zoom lens and a focus adjustment lens. Furthermore, a device such as a motor is not easily attached.

Fourth, when a subject 140 is photographed in extreme close-up, angle adjustment cannot be accurately achieved with the two lens systems 100. In addition, since the motor and a device (not shown) have to be additionally attached, the lens systems become large in size.

Fifth, when the lens systems are tilted towards a center portion in order to capture an image of a proximity subject, a keystone may be produced. This results in the generation of so-called a vertical parallax in which a left image and a right image do not coincide with each other.

In practice, broadcasting lenses of a HD (high definition) level are not manufactured from the first time for the use of three-dimensional capture. Thus, the lenses are thick (outer diameter of a typical lens is equal to or greater than 95 mm), and their main bodies are as 1.5 times as thicker as this. For this reason, the two lens systems 100 are spaced apart from each other by more than the eyespot distance (approximately 65□). As a result, when an image captured in extreme close-up is reproduced, the image is not clearly recognized by the human eye. Moreover, image capture is not readily achieved due to large volume and heavy weight of the lens systems 100.

In order to solve the problems occurring when the three-dimensional image is captured using the two lens systems 100, a three-dimensional image capturing lens system has partially been developed in which binocular lenses are included in one lens system.

For example, as shown in FIGS. 2A and 2B, a focus-free adapter lens system 210 having a binocular duplex structure may be attached to a conventional camcorder 200.

With this structure, the adapter is designed without knowing the capability of a lens of an existing camcorder. Therefore, sufficient resolution is not obtained when assembled. Further, if an image with a wide image angle is captured, it becomes difficult in maintaining a binocular distance (65 mm) since an angle becomes wide at a front portion of a camcorder lens.

In addition, when a focal length of a zoom lens built in the camcorder 200 is zoomed, an incident point of main light, that is, the location of an entrance pupil, changes. Thus, regarding the adapter lens system constructed with four lens groups L1, L2, L3, and L4, the entrance pupil has to change according to the variation of the entrance pupil required by the zoom lens.

Since the adapter lens system cannot compensate for this, a phenomenon (kerare) occurs in which an angle of view is not sufficiently formed and thus surroundings are viewed dark.

In order to synthesize left and right light beams, a beam-splitter (a device that synthesizes two light beams reflected from mirrors M1, M2, and M3) is used. Therefore, only 50% of the light beams are available and the rest 50% of the light beams are lost.

According to this structure, there is a limit in that the three-dimensional image is obtained in low image quality.

Besides the aforementioned structure, as shown in FIG. 3, a zoom lens 310 is constructed with four lens groups: a first lens group 311 that adjusts focus, a second lens group 312 that modifies and compensates for magnification, a third lens group 313, and a fourth lens group 317 that is a master lens group.

An aperture unit (not shown) is disposed behind the third lens group 313 of the zoom lens 310. A total reflection prism 315 and an X-cube 316 are disposed behind the aperture unit.

The aperture unit is disposed behind the third lens group 313 and ahead the total reflection prism 315. A rotary disk 314 is disposed at a place almost in contact with the aperture unit, whereby light of the right image is shunt when light of the left image passes through the aperture unit whereas the light of the left image is shunt when the light of the right image passes through the aperture unit. Accordingly, the left image and the right image are alternately formed on a CCD (not shown).

Two optical axes (vergence: an angle at which a subject is observed) are parallel when the distance to the subject is infinite. On the other hand, when the subject is located in a near place, the vergence changes with respect to the subject in the near place by the use of the rotation of the total reflection prism 315 located behind the third lens group 313 of the zoom lens 310.

Since the X-cube 316 is disposed between the third group lens 313 and the fourth group lens 317 so as to synthesize light, it is difficult to design the zoom lens 310 with high magnification (high zoom ratio). In practical, the zoom ratio is limited only up to about 3 times its original size.

According to this structure, when light 320 received through a binocular lens is used to synthesize a three-dimensional image by the X-cube 316, the feature of the X-cube 316 restricts the intensity of the light 320 to be used only up to 25%.

For example, when a lens is developed to have F# of 2.8, light intensity can be utilized only up to ¼ since the X-cube 316 is used to synthesize the light emitted from the left and right sides. As a result, a lens of F5.6 is obtained.

Furthermore, a double image may be formed if the X-cube 316 is not manufactured with perfect precession.

In order to solve the problems in which the X-cube 316 can use only 25% of light intensity, there is a method in which an optical divider is combined into the structure of FIG. 3. The use of the optical divider allows the light intensity to be used up to 50%. However, 100% of use is still impossible.

### DISCLOSURE OF INVENTION

### Technical Problem

In order to solve the aforementioned problems, the present invention provides a three-dimensional image capturing lens system in which a three-dimensional image can be obtained with a high zoom ratio and a high resolution without loss of light intensity by disposing, instead of using an X-cube or a beam splitter, an optical transmitter/reflector constructed with elements selected from the group consisting of a total reflection mirror and a rotary disk alternating reflection/transmission, the total reflection mirror and a galvanometer forming a mirror, or the total reflection mirror and a digital mirror. In addition, a simple structure is achieved by using one aperture unit instead of using two aperture units for binocular lenses (not shown). In particular, in the three-dimensional image capturing lens system, a focal length of a first relay lens is formed to be equal to that of a second relay lens, thereby obtaining a magnification of 1, and light transmitted through the first relay lens propagates parallel to the second relay lens for parallel incidence.

### Technical Solution

According to an aspect of the present invention, there is provided a three-dimensional image capturing lens system comprising: a front lens disposed in a front portion of an optical system thereof; a first relay lens formed behind the front lens; an optical transmitter/reflector formed behind the first relay lens so as to alternately transmit or reflect light of left and right images; a second relay lens formed behind the optical transmitter/reflector so as to compensate for image quality of an incident light; a color mixing prism formed behind the second relay lens so as to separate image quality of the compensated light incident via the second relay lens into the three primary color components of red, green, and blue; and a CCD, wherein a focal length of the first relay lens is formed to be equal to that of the second relay lens, thereby obtaining a magnification of 1, and thus a front focal position of the first relay lens is located at an image point formed by the front lens when light is viewed from an axis point of view, so that the light transmitted through the first relay lens propagates in parallel so as to be incident on the second relay lens in parallel, thereby forming a focus on an image plane.

In the aforementioned aspect of the present invention, the optical transmitter/reflector may be constructed with elements selected from the group consisting of a total reflection mirror and a rotary disk, the total reflection mirror and a galvanometer, or the total reflection mirror and a digital mirror.

In addition, the front lens may be constructed with either an attachable/detachable zoom lens or a fixed focus lens.

In addition, the galvanometer may have one or two reflection mirrors, and the reflection mirrors can rotate either left/right or up/down.

In addition, the galvanometer may be constructed so that the angle of the reflection mirror is 0° or 45° against light incident through the relay lens.

In addition, in the galvanometer, left light may be transmitted and directed towards the CCD when the angle of the reflection mirror is 0° whereas right light may be reflected and directed towards the CCD when the angle of the reflection mirror is 45°.

In addition, the rotary disk may have one or more holes.

### ADVANTAGEOUS EFFECTS

According to a three-dimensional image capturing lens system of the present invention, by the use of an optical transmitter/reflector constructed with elements selected from the group consisting of a total reflection mirror, a rotary disk, a galvanometer, and a digital mirror combined with a first relay lens and a second relay lens which have the same focal length and a magnification of 1, there is an excellent advantage in that an image formed by a front lens can be formed on one CCD without loss of light intensity.

In addition, in comparison with the conventional three-dimensional image capturing method using two lens systems, the distance between binocular lenses can be reduced to 65 mm. Furthermore, in comparison with the conventional structure employing an X-cube and the conventional structure employing a beam splitter, a three-dimensional image can be implemented without loss of light intensity. Moreover, lens replacement can be easily achieved by only replacing a front lens located in a front portion.

### BRIEF DESCRIPTION OF THE DRAWINGS

FIG. 1 is a schematic view illustrating a conventional method of capturing a three-dimensional image using two lenses.

FIG. 2 is a view illustrating a structure of an optical system for capturing a three-dimensional image using a conventional binocular focus-free adapter.

FIG. 3 is a view illustrating a structure of an optical system for capturing a three-dimensional image using a conventional X-cube.

FIG. 4A is a schematic view of a rotary disk which is a part of an optical transmitter/reflector of a three-dimensional image capturing lens system according to the present invention.

FIG. 4B is a view illustrating an optical path of a three-dimensional image capturing lens system and a structure thereof employing the rotary disk and the total reflection mirror of FIG. 4A according to the present invention.

FIG. 5 is a view illustrating a structure and an optical path of a relay lens according to the present invention.

FIG. 6 is a view illustrating an operational state of a front lens of a three-dimensional image capturing lens according to the present invention.

FIG. 7 is a view illustrating an optical transmitter/reflector according to a first embodiment of the present invention.

FIG. 8 is a view illustrating an optical transmitter/reflector according to a second embodiment of the present invention.

FIG. 9 is a view illustrating an optical transmitter/reflector according to a third embodiment of the present invention.

FIGS. 10A and 10B are views illustrating an optical transmitter/reflector according to a fourth embodiment of the present invention.

FIG. 11 is a view illustrating an optical transmitter/reflector according to a fifth embodiment of the present invention.

### BEST MODE FOR CARRYING OUT THE INVENTION

Hereinafter, a three-dimensional image capturing lens system of the present invention will be described in detail with reference to the accompanying drawings.

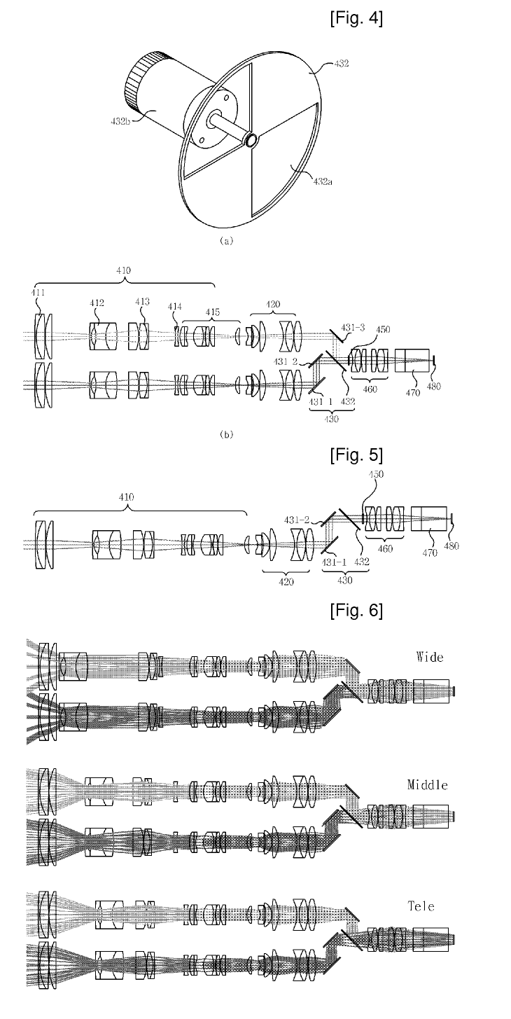

Referring to FIGS. 4A and 4B, a front lens 410 which is constructed with a fixed focus lens or a zoom lens is disposed in a front portion of the three-dimensional image capturing lens system.

According to an embodiment of the present invention, the front lens 410 is a zoom lens constructed with a first lens group 411, a second lens group 412, a third lens group 413, a fourth lens group 414, and a fifth lens group 415 that is a master lens group. The front lens 410 may be used as a fixed focus lens or a zoom lens. However, in the following descriptions, the front lens 410 will be limited to the zoom lens.

The first lens group 411 of the front lens 410 acts as a focus adjustor which allows a proximity subject to be clearly imaged. That is, the focus adjustor moves forwards as the subject comes closers, so that a clear image is detected by a CCD 480.

The second lens group 412, the third lens group 413, and the fourth lens group 414 are called as magnification varying systems which change a focal length of a zoom lens system while moving forwards and backwards so as to change the subject in terms of size and image angle.

The fifth lens group 415, the master lens group, allows the clear image to be finally formed.

A first relay lens 420 is disposed behind the fifth lens group 415 of the front lens 410.

An optical transmitter/reflector 430 is disposed behind the first relay lens 420 so that light beams of left and right images are alternately transmitted or reflected.

The optical transmitter/reflector 430 includes total reflection mirrors 431-1, 431-2, and 431-3 that change a light path and a rotary disk 432 that has one or more holes 432a through which reflection and transmission are alternately carried out instead of an X-cube. The rotary disk 432 rotates by a motor 432b.

An aperture unit 450 is disposed behind the optical transmitter/reflector 430 so as to regulate light intensity by adjusting an aperture through which a light beam (or light) is transmitted.

Here, the aperture unit 450 and the rotary disk 432 are designed to be conjugated (conjugation is defined as a term referring a relation between a pair of dots, lines, or numbers which are specifically related so that their properties are not altered even after the pairs are interchanged.) Thus, the rotary disk 432 is located so as to act as another aperture unit.

Therefore, the aperture unit 450 may be disposed between the fourth lens group 414 and the fifth lens group 415 of the front lens 410. Alternatively, the aperture unit 450 may be disposed behind a place near the rotary disk 432 of the optical transmitter/reflector 430.

In order to maintain the conjugation condition, main light emitted from the zoom lens has to maintain a specific angle during zooming (magnification changes according to focal length variation). To this end, the location of the aperture unit 450 disposed between the fourth lens group 414 and the fifth lens group 415 of the front lens 410 and the location of the fifth lens group 415 have to be designed not to change during zooming so that the main light maintains a constant emission angle.

However, if the location of the aperture unit 450 has to be changeable during zooming, the location of the optical system disposed behind the aperture unit 450 has to change so that the main light emitted from the zoom lens can maintain a constant angle.

The aperture unit 450 may be disposed between the fourth lens group 414 and the fifth lens group 415 of the front lens 410 or may be disposed behind a place near the rotary disk 432 of the optical transmitter/reflector 430. If this is the case, in order to maintain the conjugation condition, the relay lens has to be designed so that the angle of the main light of the zoom lens exactly coincides with an incident angle of the main light of the relay lens.

A second relay lens 460 is disposed behind the aperture unit 450.

A color mixing prism 470 is disposed behind the second relay lens 460. The CCD 480 is disposed behind the color mixing prism 470.

According to the structure of the present invention, when the location of an image plane where an image is formed by the front lens 410 is aligned to the location of a front focal position of the first relay lens 420, light transmitted through the first relay lens 420 becomes parallel light and then passes through a hole of the rotary disk 432 or is reflected at a place having no hole.

By utilizing the second relay lens 460, the parallel light forms an image on the CCD 480 disposed behind the color mixing prism 470.

The color mixing prism 470 separates the incident light into the three primary color components of red, green, and blue so as to form the image on the CCD 480.

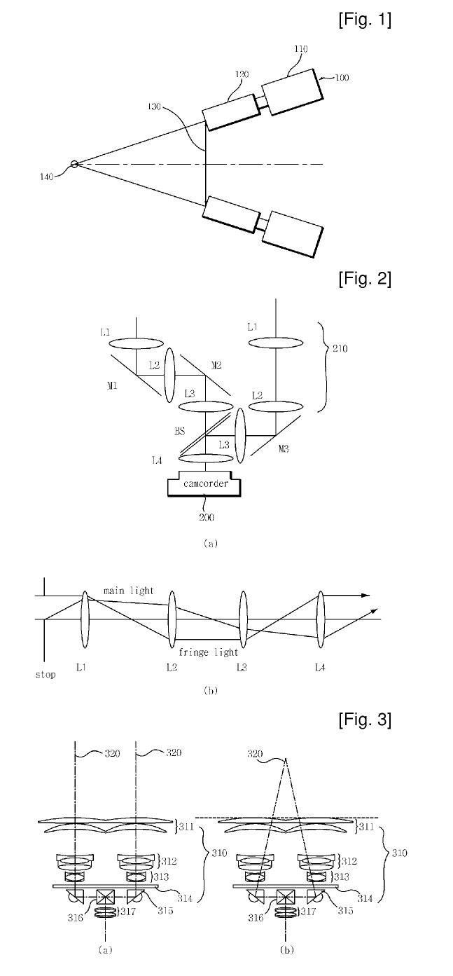

When using an extreme close-up, the total reflection mirrors 431-1, 431-2, and 431-3 not only modify a vergence but also divert an optical direction. This is performed in the same principle as when the two total reflection prisms 315 rotate about the proximity subject of FIG. 3.

The total reflection mirrors 431-1 and 431-3 rotate in an opposite direction with each other, while the total reflection mirrors 431-2 and 431-3 rotate in the same direction with each other, thereby achieving a simple mechanical structure.

In the three-dimensional image capturing lens system of the present invention, the front lens 410 has a focal length of 7.53□ to 75.3□. A zoom ratio of the zoom lens is 10, and F# is 2.8.

The CCD 480 is ⅔ inches in size (a diagonal length of an area where an image is formed in practice is 11 mm) where an aspect ratio thereof is 16:9. Therefore, the size of the CCD 480 becomes 9.59 mm wide (horizontal)×5.39 mm deep (vertical).

If a focal length is 7.53 mm, an angle of view is calculated as follows: a horizontal angle of 65° [=2×tan−1(9.59/(2×7.53))], a vertical angle of 36.6° [=2×tan−1(5.39/(2×7.53))], and an opposite angle of 74.6°[=2×tan−1(11/(2×7.5))].

In the case where the most extreme close-up length is 700 mm, a subject located at the center of a binocular distance of 65 mm is viewed at an angle of 2.658°[=tan−1(65/2/700)], which is called as vergence variation. The zoom lens has to be designed so that it can capture an image in a horizontal direction up to 67.658° (=65°+2.658°). When this is converted into an opposite angle, the zoom lens has to be designed so that good image quality can be maintained up to a diagonal length of 12.1□.

Accordingly, such a lens is designed to have an angle of view wider than that of a general lens by 10%[=(12.1−11)/11].

The first relay lens 420 is also designed in the same manner as the front lens 410 so as to accommodate an image having a diagonal length of 12.1 mm. On the other hand, the second relay lens 460 is designed to have the same diagonal length of 11 mm as in the CCD 480.

This is because the total reflection mirrors 431-2 and 431-3 rotate by the half of the changes in an angle of view for the proximity subject. As a result, a reflection angle is aligned so that the changes in the angle of view can be completely compensated for. Therefore, the optical path is uniformly formed from a place behind the total reflection mirror 431.

The focal length of the first relay lens 420 and the second relay lens 460 is 40 mm, and F# is 2.8 which is equal to that of the front lens 410.

The rotary disk 432 and the aperture unit 450 each have an aperture with a diameter of 14.29□(=40/2.8) through which light passes through.

Generally, as shown in FIG. 5 (a view illustrating a structure and an optical path of the relay lens designed to have a magnification of 1), when the focal length of the first relay lens 420 is the same as that of the second relay lens 460 so that the magnification of each relay lens becomes 1, F# of the zoom lens is equal to F# of each of the relay lenses. On the other hand, when the focal length of the first relay lens 420 is different from that of the second relay lens 460, the design is achieved in a different concept.

For example, assume that the focal length of the first relay lens 420 is 40 mm, and the focal length of the second relay lens 460 is 60 mm. In this case, even if a diagonal length of an image formed by the zoom lens is 7.333 mm by using a relay lens unit as an optical system having a magnification of 1.5×, the diagonal length becomes 11 mm at a location of the CCD 480 since the relay lens unit magnifies it by 1.5 times.

Accordingly, the size of the zoom lens can be minimized, and thus, advantageously, the binocular distance can be maintained to be 65 mm.

However, in order for a total optical system to have F# of 2.8, the zoom lens has to be designed to have F# of 1.87(=2.8/1.5).

In the operational state of the zoom lens of the front lens 410 of the three-dimensional image capturing lens system according to the present invention, as shown in FIG. 6, when the location of the image plane formed by the front lens 410 is aligned to the front focal position of the first relay lens 420, light which has passed through the first relay lens 420 becomes parallel light. Then, the light forms an image on the CCD 480 via the optical transmitter/reflector 430, the aperture unit 450, the second relay lens 460, and the color mixing prism 470. In this case, wide, middle, and tele type structures and an optical path vary depending on their features.

### MODE FOR THE INVENTION

### First Embodiment

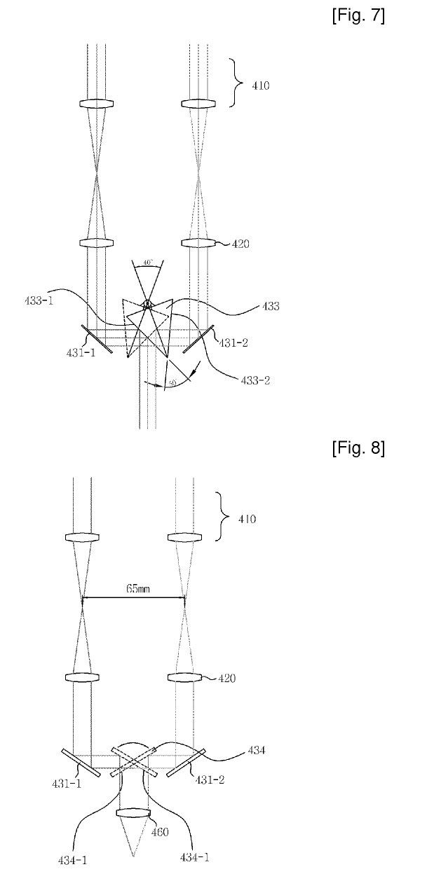

FIG. 7 illustrates a galvanometer disposed instead of a rotary disk of an optical transmitter/reflector according to a first embodiment of the present invention. Referring to FIG. 7, two front lenses 410 in the left and right sides maintain the binocular distance of 65 mm and are disposed in a front portion so that an image is formed in a space behind the front lenses 410. The image is turned into parallel light by using a first relay lens 420. In the mean time, total reflection mirrors 431-1 and 431-2 are used so that the image is synthesized by a galvanometer 433 where the two reflective mirrors 433-1 and 433-2 are attached at 50°. Accordingly, the image is formed on a CCD 480 through a second relay lens 460.

Specifically, as for an optical reflection operation, in the galvanometer 433 constructed so that the reflective mirrors 433-1 and 433-2 are formed at the both sides at 50°, the light initially incident from the left side is reflected by the total reflection mirror 431-1 and is thus refracted to the right side by 90°. In this case, if the galvanometer 433 rotates counter-clockwise by 40°, the light is reflected by the reflective mirror 433-2, is refracted by 90°, and thus directed towards the second relay lens 460.

On the contrary, the light initially incident from the right side is reflected by the total reflection mirror 431-2 and is thus refracted to the left side by 90°.

In this case, if the galvanometer 433 rotates clockwise by 40°, the light is reflected by the reflective mirror 433-1, is refracted by 90°, and thus directed towards the CCD 480.

### Second Embodiment

FIG. 8 illustrates a galvanometer disposed instead of a rotary disk 432 of an optical transmitter/reflector 430 according to a second embodiment of the present invention. Referring to FIG. 8, two front lenses 410 maintain the binocular distance of 65 mm, and light is incident through the two front lens 410 to form an image in a space behind the front lenses 410. The image is turned into parallel light by using a first rely lens 420. In the mean time, total reflection mirrors 431-1 and 431-2 are used so that the image is synthesized by a galvanometer 434 where the reflective mirror 434-1 is attached. Accordingly, the image is formed on a CCD through a second relay lens 460.

Specifically, as for an optical reflection operation of the galvanometer 434 constructed with the reflective mirror 434-1, the light initially incident from the left side is reflected by the total reflection mirror 431-1 and is thus refracted to the right side by 90°. In this case, if the galvanometer 434 rotates clockwise by 90°, the light is reflected by the reflective mirror 434-1, is refracted by 90°, and thus directed towards the CCD.

On the contrary, the light initially incident from the right side is reflected by the total reflection mirror 431-2 and is then refracted to the left side by 90°.

In this case, if the galvanometer 434 rotates counter-clockwise by 90°, the light is reflected by the reflective mirror 434-1, is refracted by 90°, and thus directed towards the second relay lens 460.

Accordingly, the galvanometer 434 having one reflective mirror is constructed to form a substantial Y-shape with respect to the total reflection mirrors 431-1 and 431-2. As the galvanometer 434 reciprocally rotates by 90°, the light beams of the left/right images are alternately reflected. As a result, the left/right images can be alternately formed on the CCD without loss of light intensity as in the case of using an X-cube.

### Third Embodiment

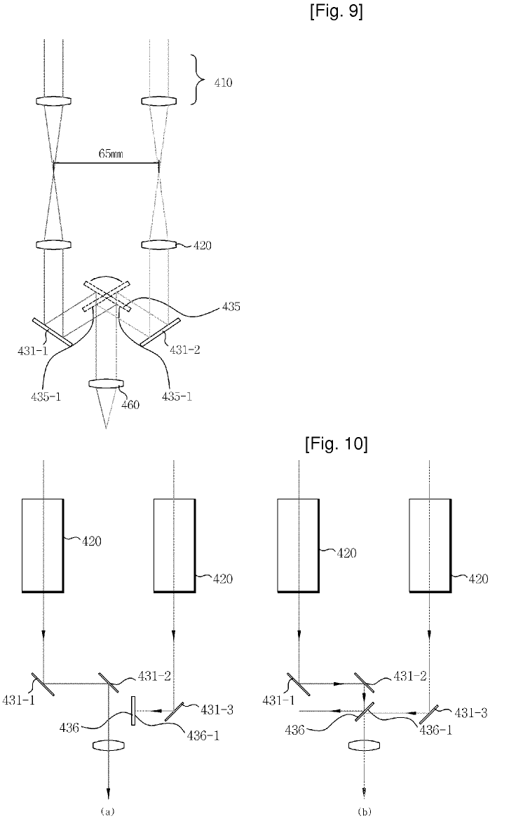

FIG. 9 illustrates a galvanometer disposed instead of a rotary disk 432 of an optical transmitter/reflector 430 according to a third embodiment of the present invention. Referring to FIG. 9, two front lenses 410 maintain the binocular distance of 65 mm and light is incident through the two front lenses 410 to form an image in a space behind the front lenses 410. The image is turned into parallel light by using a first rely lens 420. In the mean time, total reflection mirrors 431-1 and 431-2 are used so that the image is synthesized by a galvanometer 435 where the reflective mirror 435-1 is attached. Accordingly, the image is formed on a CCD through a second relay lens 460.

Specifically, as for an optical reflection operation of the galvanometer 435 constructed with the reflective mirror 435-1, the light initially incident from the left side is reflected by the total reflection mirror 431-1 and is thus refracted to the right side. In this case, if the galvanometer 435 rotates clockwise by an angle far smaller than as in the galvanometer 434 of the second embodiment, the light is reflected by the reflective mirror 435-1 and is thus directed towards the second relay lens 460.

On the contrary, the light initially incident from the right side is reflected by the total reflection mirror 431-2 and is then refracted to the left side.

In this case, if the galvanometer 435 rotates counter-clockwise by an angle far smaller than as in the galvanometer 434 of the second embodiment, the light is reflected by the reflective mirror 435-1 and thus is directed towards the second relay lens 460.

Accordingly, the galvanometer 435 having one reflective mirror is constructed to form a substantial W-shape with respect to the total reflection mirrors 431-1 and 431-2. As the galvanometer 435 reciprocally rotates to the left and right sides, the light beams for left/right images are alternately reflected. As a result, the left/right images can be alternately formed on a CCD without loss of light intensity as in the case of using an X-cube.

### Fourth Embodiment

FIGS. 10A and 10B illustrate a galvanometer disposed instead of a rotary disk of an optical transmitter/reflector according to a fourth embodiment of the present invention. Referring to FIGS. 10A and 10B, light incident through a front lens 410 and a first relay lens 420 is reflected through total reflection mirrors 431-1, 431-2, and 431-3. The light is then sent to a galvanometer 436 which is asymmetrically disposed/formed with respect to the total reflection mirrors 431-1, 431-2, and 431-3. The light is then transmitted or reflected according to changes in the angle of the galvanometer 436.

Specifically, as shown in FIG. 10A, when the galvanometer 436 is disposed to be 0° against parallel light, left parallel light is transmitted and then propagates towards the CCD, and as shown in FIG. 10B, when the galvanometer 436 is disposed to be 45° against the parallel light, right parallel light is reflected and propagates towards the CCD.

In this case, the galvanometer 436 is constructed so that the reflective mirror 436-1 rotates left/right or moves up/down for light transmission and reflection.

Now, the operation of the galvanometer 436 constructed to be rotatable to the left/right sides will be described in greater detail. When the parallel light incident from the left side of the first relay lens 420 is transmitted and thus propagates towards the CCD, the galvanometer 436 rotates to the left/right sides so as to be 0° against the parallel light. When the parallel light incident from the right side of the first relay lens 420 is reflected and thus propagates towards the CCD, the galvanometer 436 rotates to the left/right side so as to be 45° against the parallel light.

In this case, if the galvanometer 436 is located at 0° against the light being transmitted, the light transmits without being reflected.

Now, the operation of the galvanometer 436 constructed to be movable up/down will be described. When the parallel light incident from the left side of the first relay lens 420 is transmitted and thus propagates towards the CCD, the galvanometer 436 moves upwards so that the mirror 436-1 does not shut the parallel light. When the parallel light incident from the right side of the first relay lens 420 is reflected and thus directed towards the CCD, the galvanometer moves downwards so as to be 45° against the parallel light.

In this case, if the galvanometer 436 moves upwards so that light being transmitted is not blocked, the light transmits without being reflected.

When the galvanometer 436 is disposed at 45° against the light being transmitted, the light is refracted by 90° and thus propagates.

That is, according to the structure in which the galvanometer 436 is disposed at 0° or 45° against the parallel light being transmitted, before moving its position, the galvanometer 436 is fixed at 45° and thus is disposed at 45° against the parallel light. Therefore, the parallel light incident from the right side of the first relay lens 420 is reflected as to be directed towards the CCD. After the galvanometer 436 moves upwards, the galvanometer 436 is not located where the light propagates. Thus, the light incident from the right side of the first relay lens 420 cannot be directed towards the CCD, and only the light incident from the left side by the first relay lens 420 is directed towards the CCD.

### Fifth Embodiment

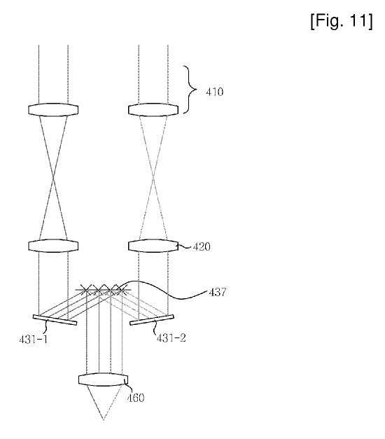

FIG. 11 illustrates a digital mirror device (DMD) instead of a rotary disk 432 of an optical transmitter/reflector 430 of the present invention. Referring to FIG. 11, light incident through a front lens 410 and a first relay lens 420 is reflected by total reflection mirrors 431-1 and 431-2 and is then sent to a DMD 437 to be reflected again. The light reflected by the DMD 437 is sent to a second relay lens 460.

The DMD 437 has a plurality of mirror cells. Each of the mirror cells simultaneously rotate to the left and right sides. Thus, parallel light transmitted by the first relay lens 420 is sent to the second relay lens 460.

The DMD 437 is also disposed to have a substantial W-shape with respect to the total reflection mirrors 431-1 and 431-2.

Accordingly, in a three-dimensional image capturing lens system of the present invention, an image is formed in a space behind the front lens 410 having a binocular distance of 65 mm and disposed in a front portion, and the image is turned into parallel light by using the first relay lens 420. Then, the parallel light is synthesized in combination of the total reflection mirrors 431-1, 431-2, and 431-3, the rotary disk, the galvanometer, and the DMD. As a result, an image is formed on the CCD by using the second relay lens 460.

1. A three-dimensional image capturing lens system comprising:
a front lens disposed in a front portion of an optical system thereof;
a first relay lens formed behind the front lens;
an optical transmitter/reflector formed behind the first relay lens so as to alternately transmit or reflect light of left and right images;
a second relay lens formed behind the optical transmitter/reflector so as to compensate for image quality of incident light;
a color mixing prism formed behind the second relay lens so as to separate image quality of the compensated light incident via the second relay lens into the three primary color components of red, green, and blue; and
a CCD,
wherein a focal length of the first relay lens is formed to be equal to that of the second relay lens, thereby obtaining a magnification of 1, and thus a front focal position of the first relay lens is located at an image point formed by the front lens when light is viewed from an axis point of view, so that the light transmitted through the first relay lens propagates in parallel so as to be incident on the second relay lens in parallel, thereby forming a focus on an image plane.

2. The three-dimensional image capturing lens system of claim 1, wherein the optical transmitter/reflector is constructed with elements selected from the group consisting of a total reflection mirror and a rotary disk, the total reflection mirror and a galvanometer, or the total reflection mirror and a digital mirror.

3. The three-dimensional image capturing lens system of claim 1, wherein the front lens is constructed with either an attachable/detachable zoom lens or a fixed focus lens.

4. The three-dimensional image capturing lens system of claim 2, wherein the galvanometer has one or two reflection mirrors, and the reflection mirrors can rotate either left/right or up/down.

5. The three-dimensional image capturing lens system of claim 4, wherein the galvanometer is constructed so that the angle of the reflection mirror is 0° or 45° against light incident through the relay lens.

6. The three-dimensional image capturing lens system of claim 5, wherein, in the galvanometer, left light is transmitted and directed towards the CCD when the angle of the reflection mirror is 0° whereas right light is reflected and directed towards the CCD when the angle of the reflection mirror is 45°.

7. The three-dimensional image capturing lens system of claim 2, wherein the rotary disk has one or more holes.
